(19) United States
(12) Patent Application Publication
(10) Pub. No.: US 2026/0098427 A1
(43) Pub. Date: Apr. 9, 2026

(54) TAMPER RESISTANT PADLOCK

(71) Applicant: Mul-T-Lock Technologies Ltd., Yavne (IL)

(72) Inventor: Adalbert Matyko, Ashdod (IL)

(73) Assignee: Mul-T-Lock Technologies Ltd., Yavne (IL)

(21) Appl. No.: 19/311,175

(22) Filed: Aug. 27, 2025

(30) Foreign Application Priority Data
Oct. 9, 2024 (GB) 2414854.6

(51) Int. Cl. E05B 67/24

(52) U.S. Cl. CPC E05B 67/24

(57) ABSTRACT

A padlock includes a body which has a cylinder lock portion and two bolt receiving portions that extend away from the cylinder lock portion, the bolt receiving portions being separated from each other by a gap, a cylinder lock received in a bore formed in the cylinder lock portion, a sliding bolt arranged to slide in apertures formed in the bolt receiving portions, a locking pin arranged to engage the sliding bolt by entering a notch formed in the sliding bolt, wherein the locking pin is urged towards the sliding bolt by a locking pin biasing device, and a locking pin blocking mechanism arranged to selectively prevent movement of the locking pin and therefore prevent movement of the sliding bolt, wherein the locking pin blocking mechanism includes a first clutch element arranged to turn freely with respect to a second clutch element, wherein the first clutch element is coupled to and turns together with the cylinder lock and the second clutch element is coupled to the locking pin and is arranged to cause movement of the locking pin that permits movement of the sliding bolt.

### FIELD OF THE INVENTION

The present invention relates generally to padlocks and particularly to a padlock with an internal protection mechanism to prevent forceful release of a shackle or sliding bolt.

### BACKGROUND OF THE INVENTION

Padlocks are commonly used to lock a hasp having a slot through which there is a projecting staple. The padlock typically includes a shackle or sliding bolt which fits through the loop of the staple and prevents the staple from removal through the hasp.

In the case of a sliding bolt, prior art padlocks are usually constructed such that the sliding bolt is held in the locked position by a pin or a spring-loaded pin that engages the sliding bolt. Inserting an authorized key in the cylinder lock of the padlock and turning the key moves the spring-loaded pin away from the sliding bolt, thereby unlocking the sliding bolt. The bolt can now be moved out of the loop of the staple.

In some padlocks, called key-retaining padlocks, the key remains in the cylinder lock after opening the padlock to allow movement of the sliding bolt and the key can be removed only after closing the sliding bolt back to the closed position. In other padlocks, called non-key-retaining padlocks, the key can be removed from the cylinder lock even after opening the padlock.

Some prior art non-key-retaining padlocks are vulnerable to forceful entry by using a hammer to strike the body of the padlock in a direction that presses the spring-loaded pin against the force of the spring and forcefully moves the spring-loaded pin out of engagement with the sliding bolt, thereby releasing the sliding bolt from the locked position, without any need for tampering with the cylinder lock of the padlock.

Clearly a need exists to prevent such an attack from defeating the locking mechanism of the padlock.

### SUMMARY

The present invention seeks to provide a padlock that solves the problem of the prior art, as is described hereinbelow. The padlock of the present invention has an internal protection mechanism to prevent forceful release of a shackle or sliding bolt, as is described below. The invention is described for a sliding bolt, but the invention is applicable for a shackle as well, and the terms sliding bolt and shackle will be used interchangeably throughout.

There is provided in accordance with a non-limiting embodiment of the invention a padlock including a body which has a cylinder lock portion and two bolt receiving portions that extend away from the cylinder lock portion, the bolt receiving portions being separated from each other by a gap, a cylinder lock received in a bore formed in the cylinder lock portion, a sliding bolt arranged to slide in apertures formed in the bolt receiving portions, a locking pin arranged to engage the sliding bolt by entering a notch formed in the sliding bolt, wherein the locking pin is urged towards the sliding bolt by a locking pin biasing device, and a locking pin blocking mechanism arranged to selectively prevent movement of the locking pin and therefore prevent movement of the sliding bolt, wherein the locking pin blocking mechanism includes a first clutch element arranged to turn freely with respect to a second clutch element, wherein the first clutch element is coupled to and turns together with the cylinder lock and the second clutch element is coupled to the locking pin and is arranged to cause movement of the locking pin that permits movement of the sliding bolt.

In accordance with a non-limiting embodiment of the invention, one end of the sliding bolt is arranged to abut against a pusher element which is biased by a pusher biasing device, wherein when the sliding bolt is released for movement by the second clutch element, the pusher biasing device urges the pusher element against the sliding bolt to urge the sliding bolt to an unlocked position.

In accordance with a non-limiting embodiment of the invention, the first clutch element includes a first clutch body formed with a cylinder lock interface slot that receives a tongue of the cylinder lock.

In accordance with a non-limiting embodiment of the invention, the locking pin blocking mechanism includes a biasing device that urges the first clutch element towards the cylinder lock and also urges the second clutch element towards the locking pin, and the biasing device can rotate freely in the first clutch element and the second clutch element.

In accordance with a non-limiting embodiment of the invention, the first clutch element includes a first clutch pin which is offset from a center of the first clutch element and which is arranged to abut against a portion of the second clutch element, so that rotation of the first clutch element causes rotation of the second clutch element.

In accordance with a non-limiting embodiment of the invention, the second clutch element includes a second clutch body formed with a step on a face of the second clutch element that faces the locking pin and which is arranged to push against a longitudinal notch formed on the locking pin.

In accordance with a non-limiting embodiment of the invention, the second clutch element includes a second clutch pin offset from a center of the second clutch element which is arranged to push against a transverse notch formed into a portion of the locking pin.

In accordance with a non-limiting embodiment of the invention, even if the locking pin is moved against the biasing device, the first clutch element can still turn to a position that permits removing a key from the cylinder lock.

### BRIEF DESCRIPTION OF DRAWINGS

The present invention will be understood and appreciated more fully from the following detailed description, taken in conjunction with the drawings in which:

FIGS. 1A and 1B are simplified exploded illustrations of a padlock, in accordance with a non-limiting embodiment of the invention.

FIG. 1C is a cutaway illustration of the padlock, showing the internal elements including the cylinder lock, sliding bolt, locking pin, and locking pin blocking mechanism.

FIG. 2 is a simplified perspective illustration of the cylinder lock, locking pin blocking mechanism, and locking pin.

FIGS. 3A and 3B are simplified perspective illustrations of the clutch elements of the locking pin blocking mechanism.

FIG. 4A is a simplified exploded illustration of the locking pin blocking mechanism and the locking pin.

FIGS. 4B and 4C are simplified perspective illustrations, respectively, of the locking pin blocking mechanism engaged with the locking pin and turned so that it is about to be disengaged from the locking pin.

### DETAILED DESCRIPTION

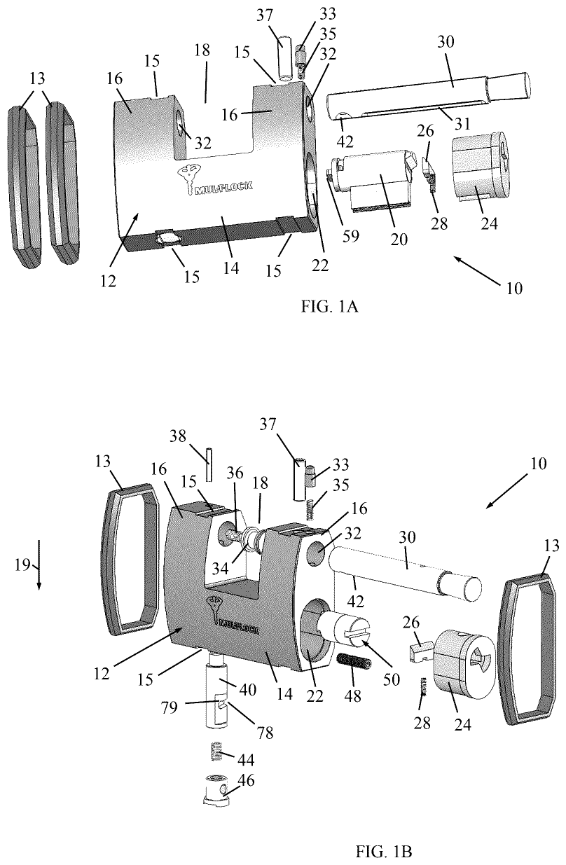

Reference is now made to FIGS. 1A, 1B, and 1C, which illustrate a padlock 10, in accordance with a non-limiting embodiment of the invention.

Padlock 10 may include a body 12 which has a cylinder lock portion 14 and two bolt receiving portions 16 that extend away from cylinder lock portion 14. The two bolt receiving portions 16 are separated from each other by a gap 18. Without limitation, body 12 may be made of a steel alloy with an electrophoretic finish. One or more bumpers 13 (such as elastomeric bands) may be placed over body 12 and bolt receiving portions 16 to protect the padlock from banging against objects. Bumpers 13 may be received in grooves 15 formed in the body 12.

A key-operated cylinder lock 20 (for simplicity, not shown in FIG. 1B) may be received in a bore 22 (FIGS. 1A and 1B) formed in cylinder lock portion 14. The front portion of cylinder lock 20 may be protectively received in a hardened cylinder protector casing 24. A keyway protective shutter 26, biased by a biasing device 28 (such as a coil spring 28), may be provided to protect the keyway entry of the cylinder lock 20, as seen in FIGS. 1A and 1B.

Padlock 10 includes a sliding bolt 30, which can slide in apertures 32 formed in the two bolt receiving portions 16. Without limitation, sliding bolt 30 may be made of a hardened boron alloy steel. As seen in FIGS. 1A and 1C, the far end of sliding bolt 30 (the left end in the sense of FIGS. 1A and 1C) may abut against a pusher element 34, which is biased by a pusher biasing device 36, such as a pusher coil spring 36. The sliding bolt 30 can be “slam” closed by pushing it against pusher element 34 and the sliding bolt 30 is “clicked” in place and held there by a locking pin 40, described below. When the sliding bolt 30 is released (as described below), the force of pusher biasing device 36 urges pusher element 34 against the sliding bolt 30 (to the right in the sense of FIGS. 1A and 1C) to urge sliding bolt 30 to an unlocked position. A pin 38 may limit the travel of pusher element 34 when it urges sliding bolt 30 to the unlocked position; that is, pin 38 retains pusher element 34 in its bolt receiving portion 16. Sliding bolt 30 may be formed with a longitudinal slot 31 (FIGS. 1A and 1C). A bolt stopper pin 33 may be urged by a spring 35 against slot 31. The bolt stopper pin 33 stops the linear sliding movement of sliding bolt 30 so sliding bolt 30 does not slide out of the padlock body. A cylinder lock stopper pin 37 may secure the cylinder lock 20 in the padlock body 12.

As seen in FIGS. 1B and 1C, a locking pin 40 is arranged to engage sliding bolt 30 by entering a notch 42 formed in sliding bolt 30. Locking pin 40 is urged towards sliding bolt 30 by a locking pin biasing device 44 (such as a coil spring 44), which is closed in body 12 by a plug 46, which is secured by a fastener 48, such as a socket set screw 48, so that plug 46 cannot be removed from the outside of body 12.

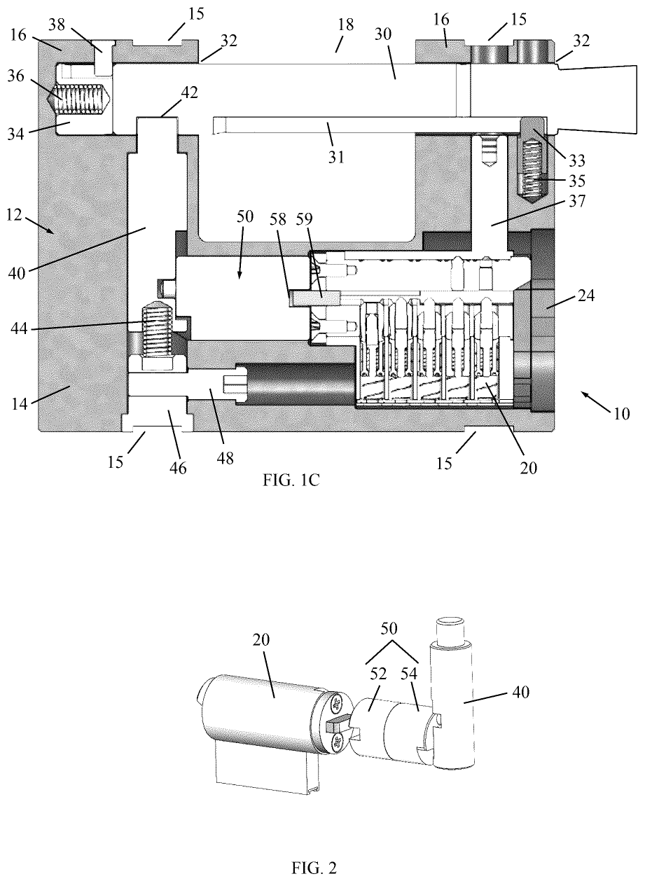

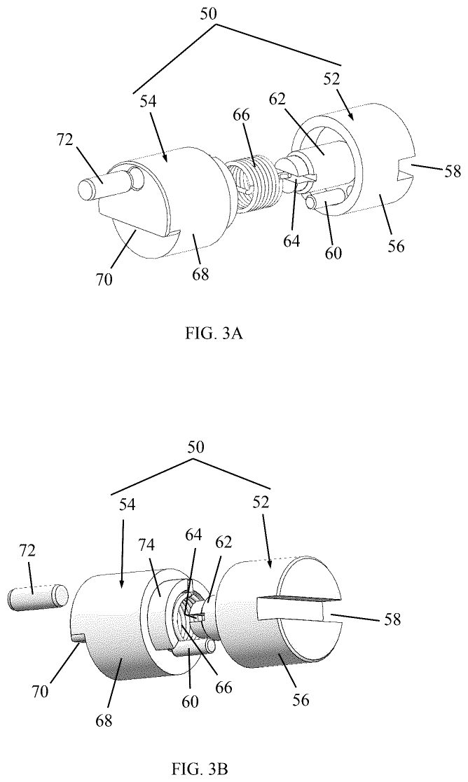

As seen in FIGS. 1B, 1C and 2, locking pin 40 is engaged by a locking pin blocking mechanism 50, which is now described with reference to FIGS. 3A and 3B.

The locking pin blocking mechanism 50 includes first and second clutch elements 52 and 54. The first clutch element 52 includes a first clutch body 56 formed with a cylinder lock interface slot 58. The cylinder lock 20 has a tongue 59 (FIGS. 1A and 1C), typically extending from the plug of the cylinder lock, which engages slot 58 to turn first clutch element 52. A far side of first clutch body 56 (the side opposite to slot 58) may include a first clutch pin 60 (for example, offset from the center of first clutch body 56) and a central protrusion 62, both of which extend from, and are secured to, first clutch body 56. The central protrusion 62 may be formed with a slot 64 that may receive a tang of a biasing device 66 received in second clutch element 54. The biasing device 66 urges first clutch element 52 towards cylinder lock 20 (FIG. 1A) and also urges second clutch element 54 towards locking pin 40. The biasing device 66 can rotate freely in first clutch element 52 and second clutch element 54.

The second clutch element 54 includes a second clutch body 68 formed with a step 70 on a face of second clutch element 54 that faces locking pin 40. Second clutch element 54 may include a second clutch pin 72 (for example, offset from the center of second clutch body 68). Second clutch element 54 may include a partial ring 74 that protrudes from the face of second clutch element 54 that faces the first clutch element 52. The first clutch pin 60 is arranged to abut against partial ring 74 (or other portion of second clutch element 54), so that rotation of the first clutch element 52 causes rotation of the second clutch element 54.

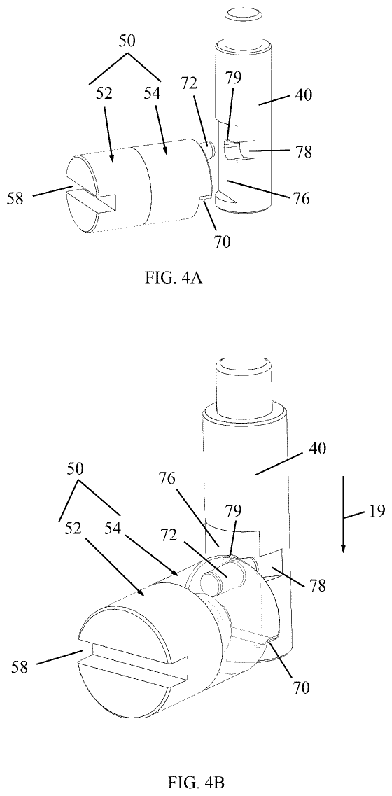

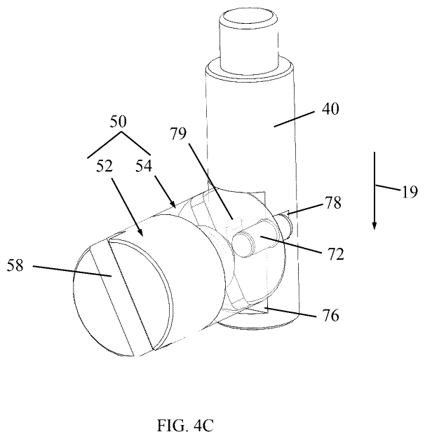

Reference is now made to FIG. 4A, which illustrates locking pin blocking mechanism 50 and locking pin 40. Locking pin 40 may be formed with a longitudinal notch 76 that extends on a perimeter of locking pin 40 along a longitudinal length of locking pin 40. A transverse notch 78 may be formed into a portion of longitudinal notch 76 that extends inwards into locking pin 40. Transverse notch 78 may be open at a perimeter of locking pin 40. An inner end of transverse notch 78 may be formed with a locking notch 79, which is a notch that extends slightly axially in the longitudinal direction of locking pin 40. As will be explained with reference to FIG. 4B, when the padlock is closed, second clutch pin 72 is received in locking notch 79 and prevents movement of locking pin 40 due to someone applying a hammer blow or similar forced to the padlock. Thus, locking pin blocking mechanism 50 cooperates with locking notch 79 to prevent movement of locking pin 40.

Reference is now made to FIG. 4B. In this position, the locking pin blocking mechanism 50 is in locked engagement with the locking pin 40. This is because second clutch pin 72 is in blocked engagement with locking notch 79. Additionally, step 70 is in blocked engagement with longitudinal notch 76. In this position, if an intruder were to strike the padlock with a hammer in an effort to drive locking pin 40 against biasing device 44 (FIGS. 1B and 1C) in the direction of arrow 19 in FIG. 1B and FIG. 4B, so as to free sliding bolt 30 without inserting anything into the cylinder lock, second clutch pin 72 is trapped in locking notch 79 so that locking pin blocking mechanism 50 blocks any movement of locking pin 40 and the attack is defeated.

Reference is now made to 4C, in which the locking pin blocking mechanism 50 has been turned (by rotating a key inserted in the cylinder lock, not shown). This rotation causes second clutch pin 72 to move out of locking notch 79 and to push down (in the sense of FIG. 4C) on transverse notch 78 and step 70 to push down on the end of longitudinal notch 76. This action causes locking pin 40 to move down and out of notch 42 (FIG. 1C) of the sliding bolt 30. Sliding bolt 30 is now unlocked and will move out of the far bolt receiving portion 16 by the urging force of pusher element 34 (FIG. 1C).

If the locking pin blocking mechanism 50 were made of one solid piece, then as long as locking pin 40 is moved down against the biasing device 44, the key would not be able to be removed from the cylinder lock. This is because just as the locking pin blocking mechanism 50 is in a turned position, the plug in the cylinder lock is also in a turned position (along the shear line) and the pins in the plug are not aligned with the driver pins, thereby preventing the key from being removed from the plug, as is known in the art. However, in the locking pin blocking mechanism 50 of the invention, first clutch element 52 turns freely with respect to second clutch element 54. Therefore, even if locking pin 40 is moved down against the biasing device 44, first clutch element 52 can still turn back to the nominal position. Since the tongue 59 of the cylinder lock (FIGS. 1A and 1C) engages slot 58 of first clutch element 52, the plug of the cylinder lock is free to rotate back to a position in which the pins in the plug are aligned with the driver pins, thereby permitting removing the key from the plug.

1. A padlock comprising:
a body which has a cylinder lock portion and two bolt receiving portions that extend away from said cylinder lock portion, said bolt receiving portions being separated from each other by a gap;
a cylinder lock received in a bore formed in said cylinder lock portion;
a sliding bolt arranged to slide in apertures formed in said bolt receiving portions;
a locking pin arranged to engage said sliding bolt by entering a notch formed in said sliding bolt, wherein said locking pin is urged towards said sliding bolt by a locking pin biasing device; and
a locking pin blocking mechanism arranged to selectively prevent movement of said locking pin and therefore prevent movement of said sliding bolt, wherein said locking pin blocking mechanism comprises a first clutch element arranged to turn freely with respect to a second clutch element, wherein said first clutch element is coupled to and turns together with said cylinder lock and said second clutch element is coupled to said locking pin and is arranged to cause movement of said locking pin that permits movement of said sliding bolt.

2. The padlock according to claim 1, wherein said locking pin is formed with a locking notch and said second clutch element comprises a second clutch pin, and when said sliding bolt is in a closed position, said second clutch pin is received in said locking notch and prevents movement of said locking pin.

3. The padlock according to claim 1, wherein one end of said sliding bolt is arranged to abut against a pusher element which is biased by a pusher biasing device, wherein when said sliding bolt is released for movement by said second clutch element, said pusher biasing device urges said pusher element against said sliding bolt to urge said sliding bolt to an unlocked position.

4. The padlock according to claim 1, wherein said first clutch element comprises a first clutch body formed with a cylinder lock interface slot that receives a tongue of said cylinder lock.

5. The padlock according to claim 1, wherein said locking pin blocking mechanism comprises a biasing device that urges said first clutch element towards said cylinder lock and also urges said second clutch element towards said locking pin, and said biasing device can rotate freely in said first clutch element and said second clutch element.

6. The padlock according to claim 1, wherein said first clutch element comprises a first clutch pin which is offset from a center of said first clutch element and which is arranged to abut against a portion of said second clutch element, so that rotation of said first clutch element causes rotation of said second clutch element.

7. The padlock according to claim 1, wherein said second clutch element comprises a second clutch body formed with a step on a face of said second clutch element that faces said locking pin and which is arranged to push against a longitudinal notch formed on said locking pin.

8. The padlock according to claim 2, wherein said second clutch pin is offset from a center of said second clutch element and is arranged to push against a transverse notch formed into a portion of said locking pin.

9. The padlock according to claim 8, wherein said transverse notch is open at a perimeter of said locking pin.

10. The padlock according to claim 3, wherein a pin limits travel of said pusher element when it urges said sliding bolt.

11. The padlock according to claim 1, wherein even if said locking pin is moved against said biasing device, said first clutch element can still turn to a position that permits removing a key from said cylinder lock.
